(19) United States
(12) Patent Application Publication
(10) Pub. No.: US 2014/0153255 A1
(43) Pub. Date: Jun. 5, 2014

(54) Luminaire

(71) Applicant: Toshiba Lighting & Technology Corporation, Yokosuka-shi (JP)

(72) Inventor: Junichi Kimiya, Yokosuka-shi (JP)

(73) Assignee: Toshiba Lighting & Technology Corporation, Yokosuka-shi (JP)

(21) Appl. No.: 14/171,945

(22) Filed: Feb. 4, 2014

Related U.S. Application Data
(63) Continuation of application No. PCT/JP2011/071997, filed on Sep. 27, 2011.

(51) Int. Cl. F21K 99/00

(52) U.S. Cl. CPC F21K 9/50
USPC 362/311.02

(57) ABSTRACT

A luminaire according to an embodiment includes a main body attached to an attachment surface such as the ceiling or the wall of a building. The luminaire includes a light-emitting surface substantially parallel to the attachment surface. A semiconductor light-emitting element is arranged on the light-emitting surface. A cover body having translucency is attached to the main body to cover the light-emitting surface. The inner surface of the cover body includes a refracting surface forming an acute angle with respect to an optical axis of light emitted from the semiconductor light-emitting element and located in a position further on the inner side than a peripheral edge section of the main body. The outer surface of the cover body includes an outer peripheral surface projecting further to the outer side than a peripheral edge section of the main body.

### CROSS-REFERENCE TO RELATED APPLICATION

This application is a continuation of International Application No. PCT/JP2011/071997, filed on Sep. 27, 2011, designating the United States, the entire contents of which are incorporated herein by reference.

### FIELD

Embodiments described herein generally relate to a luminaire attached to the ceiling or the wall of a building.

### BACKGROUND

In recent years, a luminaire using a semiconductor light-emitting element as a light source is being spread. As the luminaire of this type, for example, there is known a luminaire including a main body detachably attached to a ceiling surface, an LED module mounted with a plurality of LEDs (light-emitting diodes) on a substrate and attached to the main body, and a cover body for covering the LED module.

Since the LED has strong directivity, the luminaire of this type is suitable for lighting an object right below the luminaire. However, there is room of improvement as lighting for an entire room.

To light the entire room with the luminaire of the ceiling attachment type, it is desirable to generate light for illuminating the lateral direction and the upward direction, i.e., the ceiling, in addition to illumination light traveling downward.

Therefore, there is a demand for development of a luminaire using a semiconductor light-emitting element that can satisfactorily light the entire room.

### BRIEF DESCRIPTION OF THE DRAWINGS

FIG. 1 is a perspective view of a luminaire according to a first embodiment viewed from a light extraction side;

FIG. 2 is a perspective view of the luminaire shown in FIG. 1 viewed from an attachment surface side;

FIG. 3 is an exploded perspective view of the luminaire shown in FIG. 1;

FIG. 4 is a sectional perspective view of the luminaire shown in FIG. 1 taken along line F4-F4;

FIG. 5 is a sectional view of the luminaire shown in FIG. 4 viewed from the direction of an arrow F5;

FIG. 6 is a sectional perspective view of a luminaire according to a second embodiment;

FIG. 7 is a sectional view of the luminaire shown in FIG. 6 viewed from the direction of an arrow F7;

FIG. 8 is a simulation diagram for explaining a luminous intensity distribution characteristic by an inclined surface of a cover body of the luminaire shown in FIG. 6;

FIG. 9 is a simulation diagram for explaining the luminous intensity distribution characteristic by the inclined surface of the cover body of the luminaire shown in FIG. 6;

FIG. 10 is an explanatory diagram for explaining a relation between an inclination angle θ of the inclined surface of the cover body of the luminaire shown in FIG. 6 and an emission angle r;

FIG. 11 is a graph showing a relation between the inclination angle θ of the inclined surface that causes total reflection on the surface of the cover body of the luminaire shown in FIG. 6 and the emission angle r;

FIG. 12 is a graph showing a relation between the inclination angle θ of the inclined surface of the cover body of the luminaire shown in FIG. 6 and an amount of totally reflected light beams traveling to a side surface section;

FIG. 13 is a sectional perspective view showing a first modification of the cover body of the luminaire shown in FIG. 6;

FIG. 14 is a simulation diagram showing a luminous intensity distribution characteristic in the case in which the cover body shown in FIG. 13 is used;

FIG. 15 is a sectional perspective view showing a second modification of the cover body of the luminaire shown in FIG. 6;

FIG. 16 is a simulation diagram showing a luminous intensity distribution characteristic in the case in which the cover body shown in FIG. 15 is used;

FIG. 17 is a simulation diagram showing a luminous intensity distribution characteristic in the case in which a cover body according to another modification of the luminaire shown in FIG. 6 is used;

FIG. 18 is a simulation diagram showing a luminous intensity distribution characteristic in the case in which a cover body according to another modification of the luminaire shown in FIG. 6 is used;

FIG. 19 is a simulation diagram showing a luminous intensity distribution characteristic in the case in which a cover body according to another modification of the luminaire shown in FIG. 6 is used;

FIG. 20 is a simulation diagram showing a luminous intensity distribution characteristic in the case in which a cover body according to another modification of the luminaire shown in FIG. 6 is used;

FIG. 21 is a simulation diagram showing a luminous intensity distribution characteristic in the case in which a cover body according to another modification of the luminaire shown in FIG. 6 is used; and

FIG. 22 is a simulation diagram showing a luminous intensity distribution characteristic in the case in which a cover body according to another modification of the luminaire shown in FIG. 6 is used.

### DETAILED DESCRIPTION

In general, according to one embodiment, there is provided a luminaire including: a main body attached to an attachment surface such as a ceiling or a wall of a building; a semiconductor light-emission element arranged on a light-emitting surface substantially parallel to the attachment surface; and a cover body having translucency that is attached to the main body to cover the light-emitting surface, wherein an inner surface of the cover body includes a refracting surface forming an acute angle with respect to an optical axis of light emitted from the semiconductor light-emitting element and located further on an inner side than a peripheral edge section of the main body, and an outer surface of the cover body includes an outer peripheral surface projecting further to an outer side than the peripheral edge section of the main body.

In the luminaire, thickness from the refracting surface to the outer peripheral surface of the cover body may be larger than thickness of a front surface section of the cover body substantially parallel to the light-emitting surface.

In the luminaire, the outer surface of the cover body may include a rear side light emission surface opposed to the attachment surface further on the outer side than the peripheral edge section of the main body.

In the luminaire, the rear side light emission surface may be present in a position closer to the attachment surface than the light-emitting surface.

In the luminaire, the refracting surface may include an inclined surface inclined in a direction away from the attachment surface from the outer side toward the inner side of the cover body.

In the luminaire, the refracting surface may include a gently curved inclined surface having a sectional shape, thickness of which gradually increases from the inner side toward the outer side of the cover body.

In the luminaire, when a maximum emission angle with respect to the optical axis of the light emitted from the semiconductor light-emitting element is represented as r and a refractive index of the cover body is represented as n, an inclination angle θ of the inclined surface with respect to the light-emitting surface may be set in a range satisfying r≧θ+arcsin(n*sin(−θ+arcsin(1/n)·180/π)).

In the luminaire, the cover body may have a sectional shape, thickness of which gradually increases from the inner side toward the outer peripheral surface of the cover body.

In the luminaire, the outer surface separated from the attachment surface of the cover body close to the peripheral edge section of the front surface section may incline in a direction away from the attachment surface from the inner side toward the outer peripheral surface of the cover body.

In the luminaire, the cover body may be manufactured by injection molding using a die.

In the luminaire, a fine uneven surface may be formed on at least one of an outer side surface and an inner side surface of the cover body.

In the luminaire, a material of the cover body may contain a material having a different refractive index that irregularly reflects light.

### First Embodiment

Embodiments are explained below with reference to the drawings.

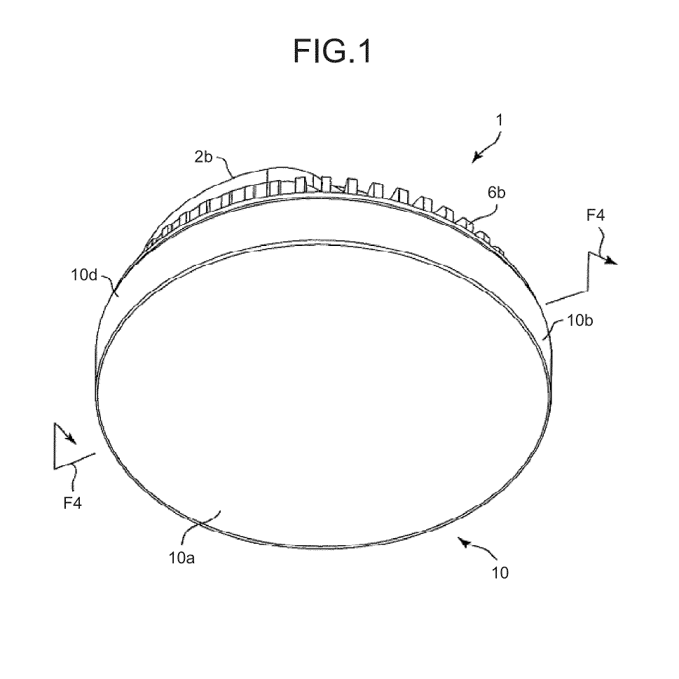

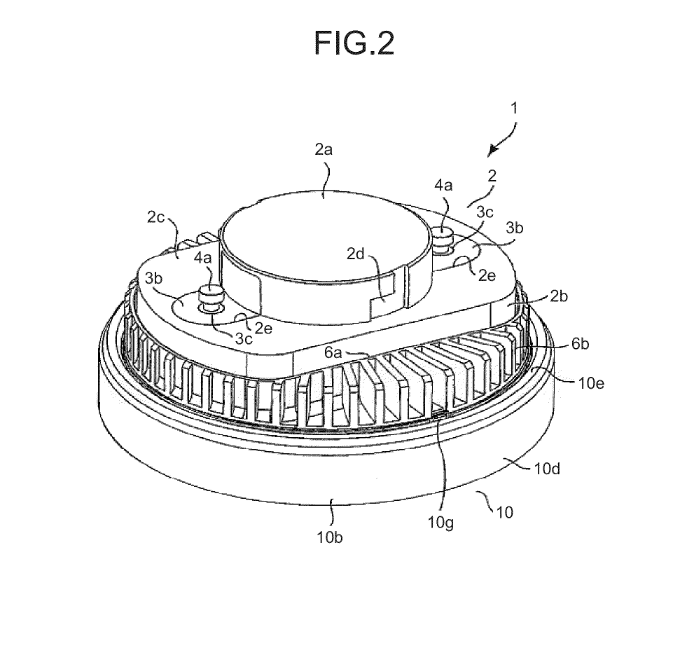

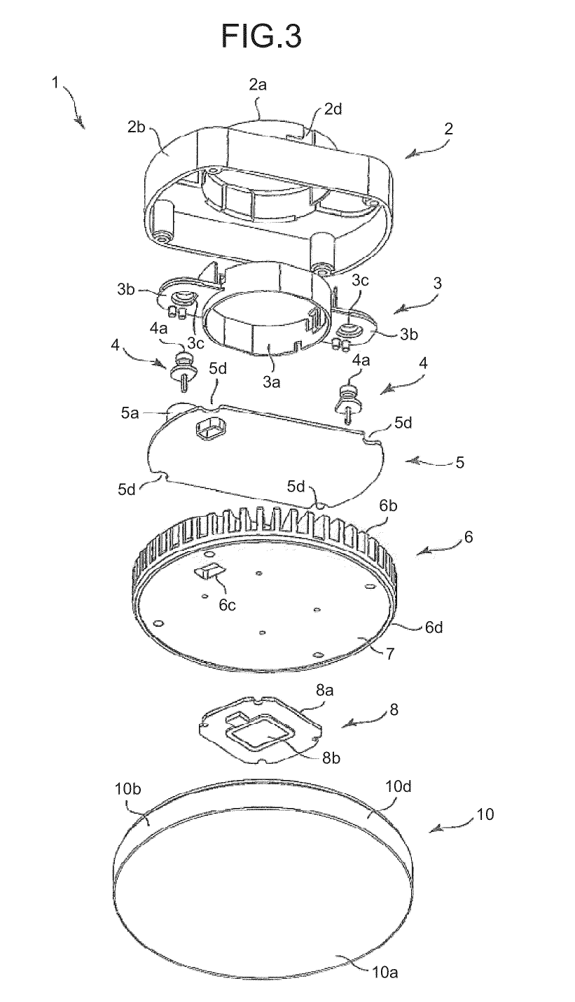

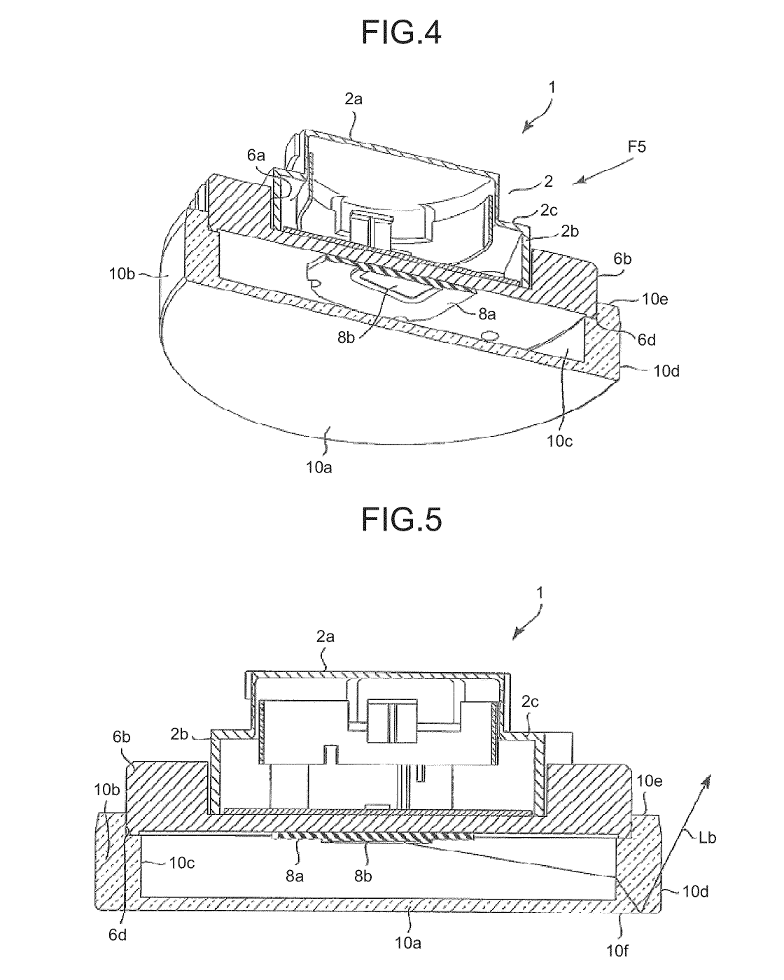

FIG. 1 is a perspective view of a luminaire 1 according to a first embodiment viewed from a light extraction side. FIG. 2 is a perspective view of the luminaire 1 viewed from an attachment surface side (hereinafter sometimes referred to as rear surface side as well) such as the ceiling or the wall. FIG. 3 is an exploded perspective view of the luminaire 1 disassembled into a plurality of components. FIG. 4 is a sectional view of the luminaire 1 shown in FIG. 1 taken along line F4-F4. FIG. 5 is a sectional view of the luminaire 1 shown in FIG. 4 viewed from an arrow F5 direction.

The luminaire 1 in this embodiment includes a cap 2 detachably attached to a not-shown socket set on an attachment surface such as the ceiling or the wall, an insulating member 3, two electrode pins 4, an inner lid 5, a housing 6 functioning as a heat radiating member, an LED module 8 attached to an attaching surface 7 of the housing 6, and a cover body 10 having translucency attached to the housing 6 to cover the LED module 8.

The cap 2 is a GX53 type and includes a bottomed cylindrical body 2a inserted through an insert-through hole of a not-shown socket. The cap 2 includes a bottomed frame body 2b having a substantially elliptical external shape. The cylindrical body 2a is integrally protrudingly provided from a bottom section 2c of the frame body 2b toward the rear surface side. On the outer peripheral surface of the cylindrical body 2a, L-shaped two grooves 2d hooked to not-shown protrusions present in the insert-through hole of the not-shown socket are formed. In the bottom section 2c of the frame body 2b, two holes 2e for respectively exposing two projecting sections 3b of the insulating member 3 are formed.

The insulating member 3 is formed by, for example, resin and includes a substantially circular frame body 3a and the two projecting sections 3b projecting to the outer side of the frame body 3a toward directions opposite to each other. In the projecting sections 3b, insert-through holes 3c through which the distal ends of the two electrode pins 4 are respectively inserted are formed. The insulating member 3 is arranged on the inner side of the frame body 2b of the cap 2. The two projecting sections 3b are respectively fit in the two holes 2e of the bottom section 2c. That is, the frame body 3a of the insulating member 3 is fit in the inner side of the cylindrical body 2a of the cap 2. The two projecting sections 3b of the insulating member 3 are exposed from the two holes 2e of the cap 2.

The two electrode pins 4 are arranged to be inserted through the insert-through holes 3c formed in the two projecting sections 3b of the above-mentioned insulating member 3. The two projecting sections 3b of the insulating member 3 are respectively fit in the two holes 2e of the cap 2. Therefore, two electrode pins 4 are in an electrically insulated state with respect to the cap 2. Note that distal ends 4a of the two electrode pins 4 project to the rear surface side of the cap 2.

The inner lid 5 integrally includes two boss sections 5a on a surface on a side facing the insulating member 3 (an upper surface in FIG. 3). The two boss sections 5a respectively include holes (not shown) for receiving proximal end sections of the two electrode pins 4. The boss sections 5a include cutouts (not shown) for allowing a not-shown lead wire for electrically connecting the electrode pins 4 to pass. The inner lid 5 is fit in the inner side of the substantially elliptical frame body 2b of the above-mentioned cap 2. At this point, screw holes provided at four corners of the frame body 2b are exposed from cutouts 5d provided at four corners of the inner lid 5.

The housing 6 includes, on the opposite side of the attaching surface 7 to which the LED module 8 is attached, a substantially elliptical concave section 6a in which the cap 2, the insulating member 3, and the inner lid 5 are housed in a combined state. The housing 6 includes a plurality of thermal radiation fins 6b on the outer side of the concave section 6a. Further, the housing 6 includes, in the bottom of the concave section 6a, a hole 6c for allowing the above-mentioned not-shown lead wire to pass. The housing 6 has a substantially columnar external shape. The housing 6 is fastened and fixed by screwing not-shown four screws in the screw holes of the cap 2. That is, the cap 2, the insulating member 3, the electrode pins 4, the inner lid 5, and the housing 6 function as a main body of the luminaire 1.

The LED module 8 includes a substrate 8a thermally adhered to the attaching surface 7 of the housing 6 in close contact therewith, a not-shown plurality of LED chips (semiconductor light-emitting elements) mounted on the surface of the substrate 8a, and a sealing member 8b that seals the plurality of LED chips on the substrate surface. The LED chips are flip-chip connected to a wiring pattern formed on the substrate surface. The wiring pattern on the substrate surface is electrically connected to the two electrode pins 4 via the above-mentioned lead wire. Note that the substrate surface functions as a light-emitting surface.

The cover body 10 includes a substantially disc-like front surface section 10a separated substantially in parallel from the substrate surface and a substantially ring-like side surface section 10b integrally protrudingly provided from the peripheral edge section of the front surface section 10a toward the housing 6 (the main body). The cover body 10 is formed by injection molding by transparent resin such as polycarbonate or acrylic. In this embodiment, the wall thickness of the side surface section 10b is larger than the plate thickness of the front surface section 10a. The cover body 10 is engaged with and attached to the housing 6 by engagement claws 10g present at ends of the side surface section 10b separated from the front surface section 10a.

Note that the side surface section 10b includes an inner peripheral surface 10c present further on the inner side than a peripheral edge section 6d of the housing 6 and an outer peripheral surface 10d projecting further to the outer side than the peripheral edge section 6d of the housing 6. As a result, the side surface section 10b includes a ring-like rear side light emission surface 10e opposed to the attachment surface further on the outer side than the peripheral edge section 6d of the housing 6. The rear side light emission surface 10e is present in a position closer to the attachment surface than the substrate surface (the light-emitting surface) of the LED module 8.

In the luminaire 1 having the above-mentioned structure, most of light emitted from the LED module 8 is emitted via the front surface section 10a of the cover body 10. On the other hand, a part of the light emitted from the LED module 8 is emitted via the side surface section 10b of the cover body 10 as indicated by an arrow Lb in FIG. 5. In particular, the light indicated by the arrow Lb lights the attachment surface to which the luminaire 1 is attached. Note that, in the luminaire 1 in this embodiment, since there is no obstacle on an optical path extending from the LED module 8 to the side surface section 10b, light passing through the side surface section 10b increases.

When focusing on the light of the arrow Lb, the light emitted from the LED module 8 toward the side surface section 10b of the cover body 10 is directly transmitted through the side surface section 10b or refracted on the inner peripheral surface 10c of the side surface section 10b, reflected on the surface (an end face 10f) of the cover body 10, and emitted to the outside of the luminaire 1 via the outer peripheral surface 10d of the side surface section 10b. When the light is emitted to the outside, since an incident angle of the light with respect to the inner peripheral surface 10c of the side surface section 10b has latitude, the light is emitted via the rear side light emission surface 10e or the light is emitted via the outer peripheral surface 10d. If a substance for scattering the light is mixed in the cover body 10, the light is irregularly reflected in the side surface section 10b of the cover body 10. The entire side surface section 10b can be shone.

In particular, according to this embodiment, since the wall thickness of the side surface section 10b of the cover body 10 is set large, it is possible to set an area of the end face 10f of the side surface section 10b on the opposite side of the rear side light emission surface 10e relatively large and relatively increase reflected light traveling to the rear side of the luminaire 1. That is, if the luminaire 1 according to this embodiment is attached to the ceiling, it is possible to brightly light the entire room.

Note that, by providing the inner peripheral surface 10c of the side surface section 10b further on the inner side than the peripheral edge section 6d of the housing 6 as in this embodiment, it is possible to increase the wall thickness of the side surface section 10b without increasing the outer diameter of the luminaire 1 more than necessary. Similarly, by projecting the outer peripheral surface 10d of the side surface section 10b further to the outer side than the peripheral edge section 6d of the housing 6, it is possible to increase the wall thickness of the side surface section 10b. In addition, it is possible to provide the rear side light emission surface 10e facing the rear surface side of the luminaire 1 and it is possible to more effectively light the attachment surface of the luminaire 1. In particular, by setting the rear side light emission surface 10e closer to the attachment surface than the light-emitting surface of the LED module 8 as in this embodiment, it is possible to more effectively carry out the lighting of the attachment surface. Note that the inner peripheral surface 10c of the side surface section 10b of the cover body 10 functions as a refracting surface for refracting the light emitted from the LED module 8.

The cover body 10 in this embodiment can be manufactured by injection molding using a die and can be manufactured relatively inexpensively. Therefore, the inner peripheral surface 10c functioning as the refracting surface of the cover body 10 forms an acute angle with respect to the optical axis of the light emitted from the LED module 8.

On the other hand, if a manufacturing method by blow molding is adopted as in the past, a tact time of molding increases and, therefore, manufacturing costs increase. That is, by manufacturing the cover body 10 with the injection molding as in this embodiment, it is possible to reduce the manufacturing costs for the luminaire 1.

By using the LED chip as the light source as in this embodiment, it is possible to extend the service life of the luminaire 1, it is possible to reduce the number of times of replacement work for the light source, and it is possible to reduce maintenance costs. As the semiconductor light-emitting elements, an EL (electroluminescence) may be used besides the LED chip. Since the cover body 10 is formed by polycarbonate or acrylic, it is possible to secure safety, for example, when the luminaire 1 drops.

Note that, in the luminaire 1 in this embodiment, if a fine uneven surface is formed on the outer side surface or the inner side surface of the cover body 10 to scatter light, it is possible to increase light beams traveling to the side surface of the luminaire 1 or backward and it is possible to improve the value of the luminaire 1. If a material having a different refractive index that irregularly reflects light is contained in the material itself of the cover body 10, it is possible to increase light beams traveling to the side surface of the luminaire 1 or backward and it is possible to improve the value of the luminaire 1.

### Second Embodiment

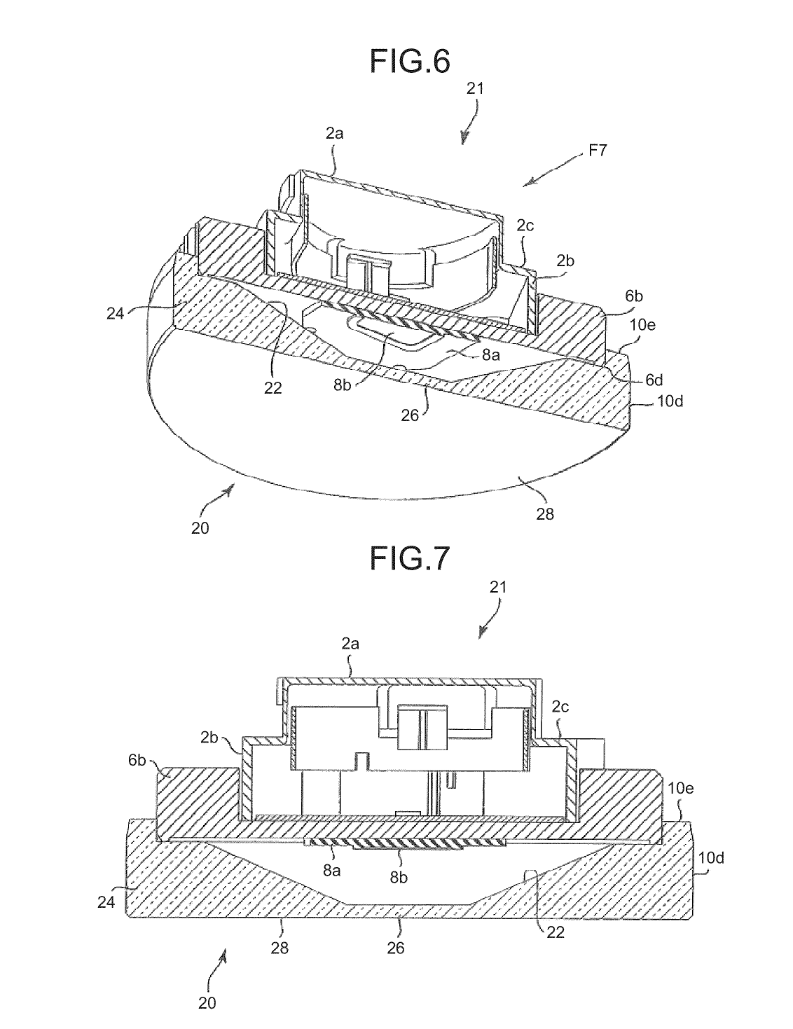

FIG. 6 is a sectional perspective view of a luminaire 21 according to a second embodiment. FIG. 7 is a sectional view of the luminaire 21 shown in FIG. 6 viewed from the direction of an arrow F7. The luminaire 21 has substantially the same structure as the luminaire 1 in the first embodiment except that the structure of a cover body 20 is different. Therefore, in this explanation, components functioning in the same manner as the components of the luminaire 1 in the first embodiment are denoted by the same reference numerals and signs and detailed explanation of the components is omitted.

The cover body 20 of the luminaire 21 in this embodiment includes a side surface section 24, an inner peripheral surface 22 of which inclines in a direction away from an attachment surface from the outer side toward the inner side of the cover body 20. In other words, the inclined surface 22 present on the inner surface of the cover body 20 inclines in a direction gradually approaching a front surface section 26 toward the inner side of the cover body 20. That is, the inclined surface 22 is continuous to the inner surface of the front surface section 26. The inclined surface 22 functions as a refracting surface for refracting light emitted from the LED module 8.

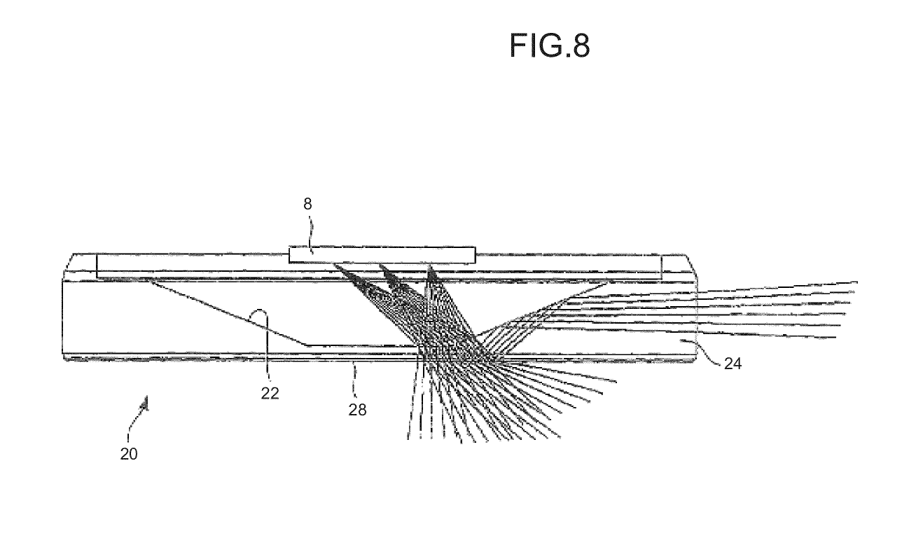

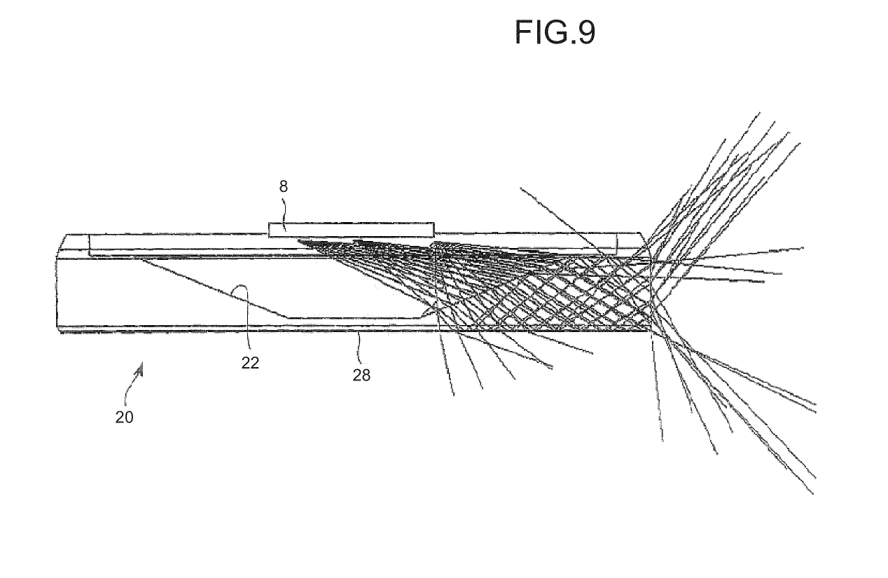

The inclined surface 22 functions to refract the light emitted from the LED module 8 to a desired direction and totally reflect the light on a surface 28 of the cover body 20. In other words, an inclination angle θ of the inclined surface 22 with respect to the surface 28 (or a light-emitting surface of a substrate surface) has a threshold for enabling the light from the LED module 8 to be totally reflected on the surface 28. For example, a simulation result of a reflecting direction of light in the case in which the inclination angle is set to 20 degrees is shown in FIG. 8 and FIG. 9.

According to the simulation result, as shown in FIG. 8, it is seen that light passing through the flat front surface section 26 of the cover body 20 is generally emitted substantially straightly via the surface 28 of the cover body 20. As shown in FIG. 8, a part of light passing through the inclined surface 22 is also emitted via the surface 28 of the cover body 20.

On the other hand, it is seen that, since most of lights passing through the inclined surface 22 are refracted on the inclined surface 22, an incident angle of the lights with respect to the surface 28 changes and the lights are totally reflected on the surface 28 and emitted from the side surface section 24 of the cover body 20 as shown in FIG. 9. When the lights are emitted, the directions of the lights emitted via the side surface section 24 are varied according to reflection routes of the lights, and are directions to the side or the back of the luminaire 21.

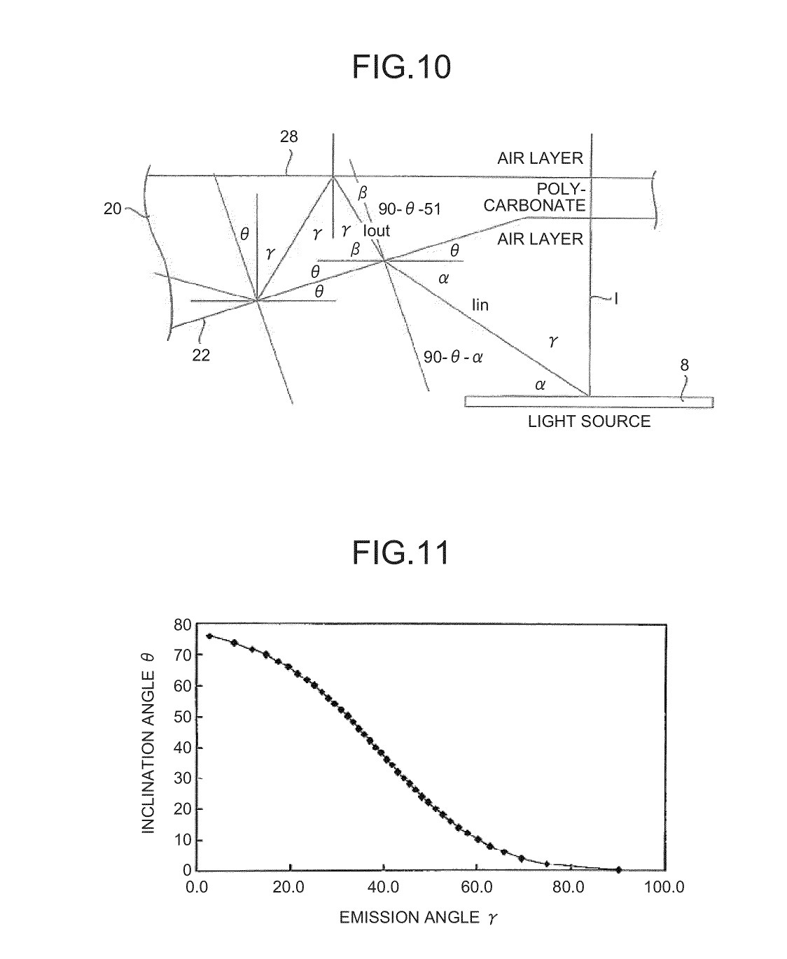

Characteristics of the inclined surface 22 are explained more specifically with reference to FIG. 10.

When a maximum emission angle with respect to an optical axis I of light emitted from the LED module 8 functioning as the light source is represented as r, an incident angle of light Iin with respect to the inclined surface 22 is r−θ. In this case, the maximum emission angle r is defined as a maximum angle for enabling light of the LED to be sufficiently extracted. The light made incident on the inclined surface 22 at the incident angle r−θ is refracted on the inclined surface 22 and passes through the cover body 20 as light Iout having an emission angle 90−β−θ.

A refractive index n of the cover body 20 formed by polycarbonate is 1.59. Therefore, an angle γ for enabling light to be totally reflected on the surface 28 of the cover body 20 is 39°. That is, the light passing through the polycarbonate as the emission light Iout having β equal to or smaller than 51 degrees is totally reflected on the surface 28. Note that, thereafter, the light reflected on the surface 28 repeats reflection between the inclined surface 22 and the surface 28 and is emitted via the outer peripheral surface 10d of the side surface section 24.

In the above explanation, the cover body 20 is formed by polycarbonate. However, the idea explained above also holds when the cover body 20 is formed by other materials. That is, when the refractive index of the cover body 20 is represented as n, the inclination angle θ of the inclined surface 22 with respect to the light-emitting surface only has to be set in a range satisfying r≧θ+arcsin(n*sin(−θ+arcsin(1/n)·180/π)).

The above numerical expression is explained below with reference to FIG. 10.

When the maximum emission angle from the LED module 8 is represented as r and the inclination angle of the inclined surface 22 with respect to the light-emitting surface is represented as θ, an incident angle of the incident light Iin with respect to the inclined surface 22 is 90−θ−α and the emission angle of the emission light Iout with respect to the inclined surface 22 is 90−(β+θ).

On the other hand, as a condition of the total reflection on the surface 28 of the cover body 20, the incident angle γ with respect to the surface 28 needs to satisfy sin γ=1/n. In this case, n indicates the refractive index of the cover body 20 and is, in this embodiment, the refractive index 1.59 of polycarbonate. That is, the incident angle γ for causing the total reflection is 39 degrees. Therefore, β=51 degrees. That is, if β is set to be smaller than 51 degrees, the condition in this embodiment is satisfied.

From the Snell's law, a relation between Iin and Iout is 1*sin(90−θ−α)=1.59*sin(90−θ−51). Therefore, a condition under which the total reflection occurs is r≧θ+arcsin(1.59*sin(90−θ−51)).

For example, in the case of an inclination angle of 20 degrees, the simulation result of which is shown in FIG. 8 and FIG. 9, the total reflection occurs at the emission angle r equal to or larger than 51.1 degrees. If the above expression is replaced with a general expression in the case in which a cover body having the refractive index n is used, r≧θ+arcsin(n*sin(−θ+arcsin(1/n)·180/π)) is obtained.

In FIG. 11, a relation between the emission angle r and the inclination angle θ in the case in which the refractive index of polycarbonate is substituted in n of the above expression is shown as a graph. According to the graph, it is seen that, for example, if the inclination angle θ of the inclined surface 22 of the cover body 20 is designed to 20 degrees, light beams having the emission angle equal to or larger than 51 degrees can be totally reflected.

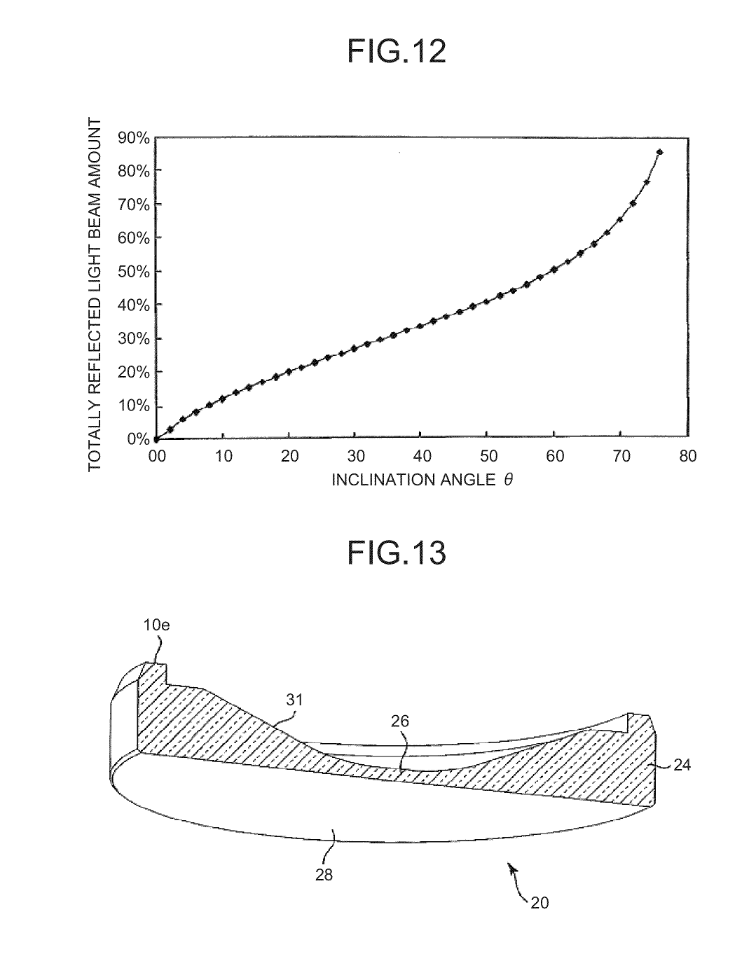

In FIG. 12, a relation between the inclination angle θ and a ratio of light beams traveling to the side surface section 24 in the light emitted from the LED module 8 in the case in which a luminous intensity distribution of the light emitted from the LED module 8 is assumed to be Lambersian is shown as a graph. According to the graph, it is seen that, for example, if the inclination angle θ of the inclined surface 22 of the cover body 20 is set to 20 degrees, light beams of about 20% of all light beams are reflected toward the side surface section 24.

The graph of FIG. 12 is a result calculated with the transmittance of the cover body 20 set to 100%. Therefore, actually, the transmittance needs to be taken into account. If the inclination angle θ is set too large, reflection is repeated because of the inclination angle θ and light beams are attenuated. Therefore, it is necessary to design the shape of the cover body 20 taking into account the thickness and the diameter of the entire cover body 20, the length of the inclined surface 22, an overall luminous intensity distribution, a light beam amount, a desired emitted light amount from the side surface section 24, and the like.

As explained above, according to this embodiment, since the inclined surface 22 is provided on the inner surface of the cover body 20, most of the light emitted from the LED module 8 can be emitted to the side or the rear side of the luminaire 21 via the side surface section 24. It is possible to light the attachment surface and it is possible to brightly light the entire room.

### Modifications of Second Embodiment

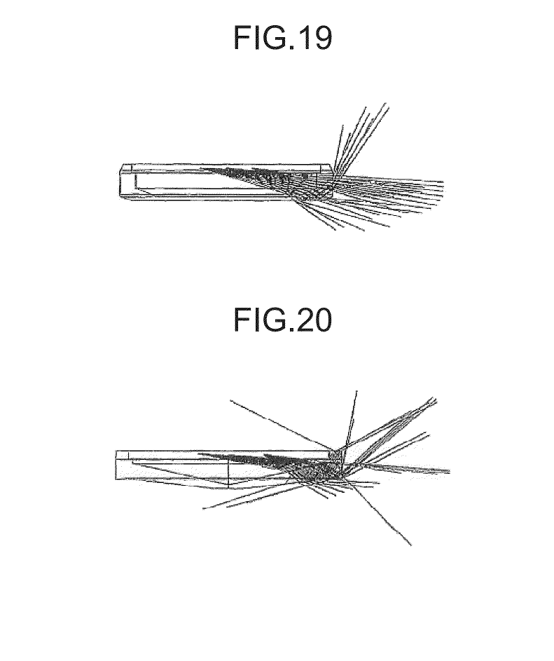

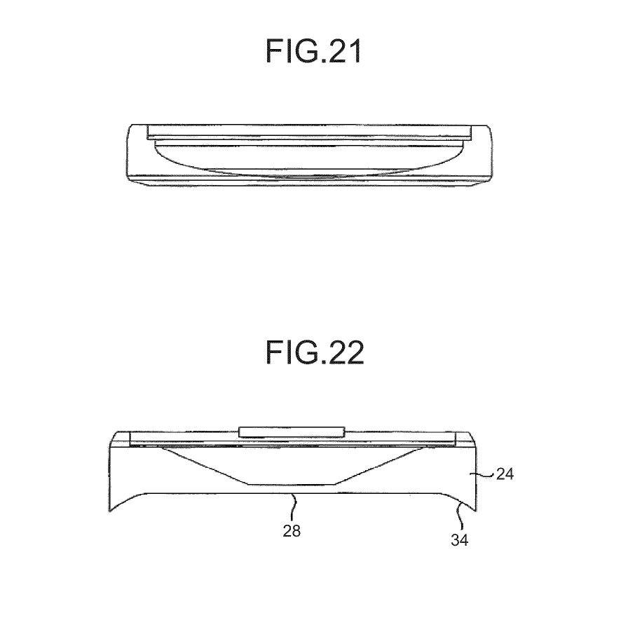

Several modifications of the cover body 20 in the second embodiment explained above are explained below with reference to FIG. 13 to FIG. 22. Note that, in the following explanation of the modifications, components functioning in the same manner as the components of the cover body 20 in the second embodiment are denoted by the same reference numerals and signs.

FIG. 13 is a first modification. The cover body 20 in the first modification includes a curved inclined surface 31 gently connected to the inner surface of the front surface section 26. The inclined surface of the cover body 20 plays a function of refracting a light beam emitted from the LED module 8 and totally reflecting the light beam on the surface 28. To cause the totally reflected light beam to travel to the side surface section 24, the inclined surface does not always need to be a straight surface. In other words, the cover body only has to have a sectional shape, the thickness of which gradually increases from the inner side toward the outer side.

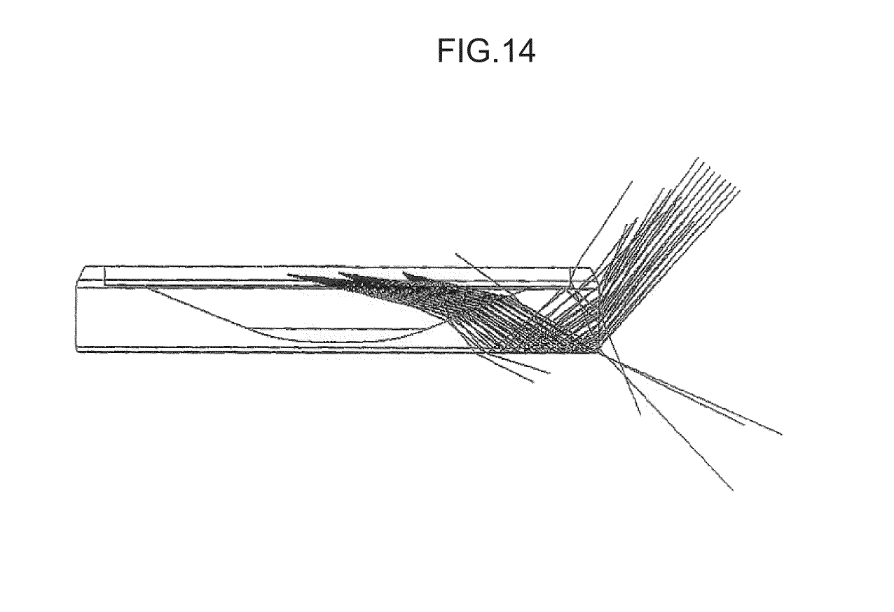

FIG. 14 is a diagram of a simulation result obtained by calculating a luminous intensity distribution characteristic in the case in which the cover body shown in FIG. 13 is used. According to the simulation result, it is seen that a large number of light beams are emitted via the side surface section of the cover body and light also the attachment surface to which the luminaire is attached. That is, it is seen that it is also possible to brightly light the entire room when the cover body in the first modification is used.

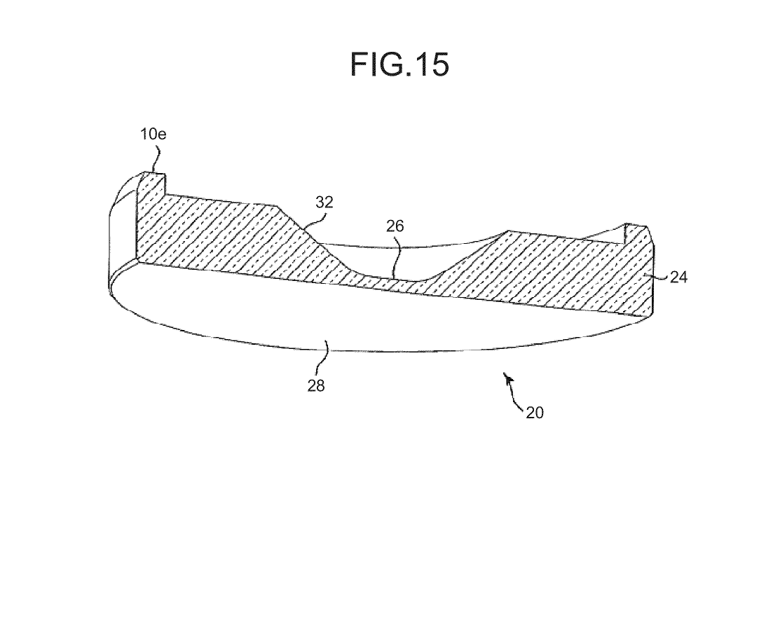

FIG. 15 is a second modification. The cover body 20 in the second modification includes a curved inclined surface 32, the inclination angle θ of which is large compared with the first modification explained above. The cover body also has a sectional shape, the thickness of which gradually increases from the inner side toward the outer side.

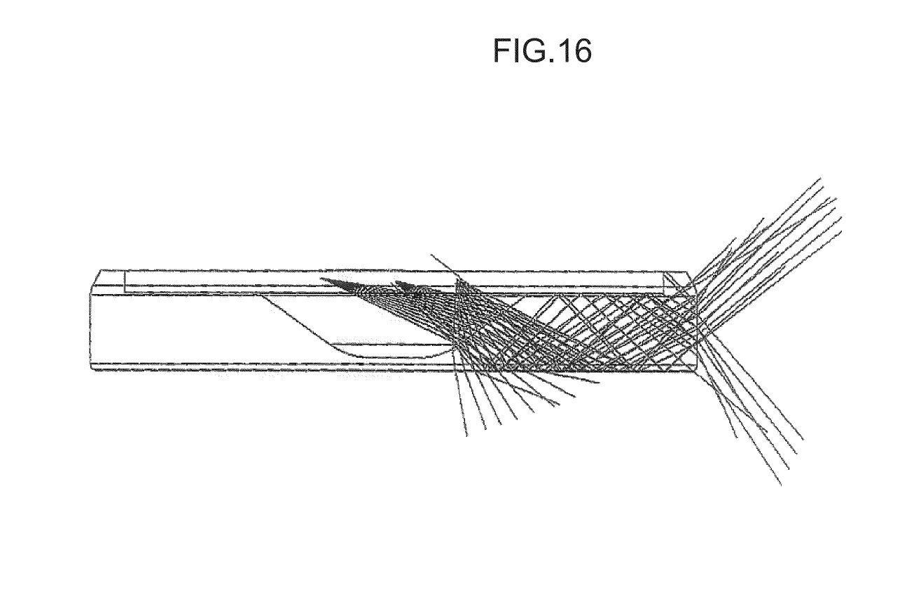

FIG. 16 is a diagram of a simulation result obtained by calculating a luminous intensity distribution characteristic in the case in which the cover body shown in FIG. 15 is used. According to the simulation result, it is seen that, compared with the first modification, an amount of light beams traveling to the side surface section 24 is large and an amount of reflected light beams is also large.

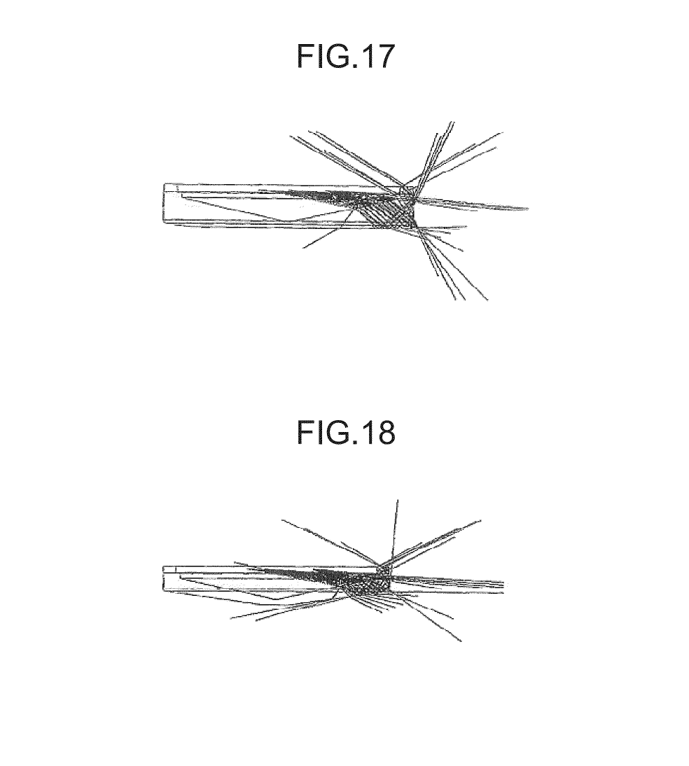

Besides, several modifications shown in FIG. 17 to FIG. 22 are conceivable. It is seen that, in all the modifications, a large amount of light is transmitted through the side surface section in addition to light transmitted through the front surface section of the cover body and the attachment surface can also be lit.

In particular, in an example shown in FIG. 22, an end face 34 separated from the attachment surface of the side surface section 24 of the cover body inclines in a direction away from the attachment surface from the inner side toward the outer side of the cover body. According to the example, it is possible to reflect a light beam to the outer side in an edge portion of the surface 28 of the cover body and it is possible to perform a luminous intensity distribution having a wider spread.

As explained above, the luminaire using the semiconductor light-emitting element according to the embodiment can satisfactorily light the attachment surface.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A luminaire comprising:
a main body attached to an attachment surface such as a ceiling or a wall of a building;
a semiconductor light-emission element arranged on a light-emitting surface substantially parallel to the attachment surface; and
a cover body having translucency that is attached to the main body to cover the light-emitting surface, wherein
an inner surface of the cover body includes a refracting surface forming an acute angle with respect to an optical axis of light emitted from the semiconductor light-emitting element and located further on an inner side than a peripheral edge section of the main body, and an outer surface of the cover body includes an outer peripheral surface projecting further to an outer side than the peripheral edge section of the main body.

2. The luminaire according to claim 1, wherein thickness from the refracting surface to the outer peripheral surface of the cover body is larger than thickness of a front surface section of the cover body substantially parallel to the light-emitting surface.

3. The luminaire according to claim 1, wherein the outer surface of the cover body includes a rear side light emission surface opposed to the attachment surface further on the outer side than the peripheral edge section of the main body.

4. The luminaire according to claim 3, wherein the rear side light emission surface is present in a position closer to the attachment surface than the light-emitting surface.

5. The luminaire according to claim 1, wherein the refracting surface includes an inclined surface inclined in a direction away from the attachment surface from the outer side toward the inner side of the cover body.

6. The luminaire according to claim 1, wherein the refracting surface includes a gently curved inclined surface having a sectional shape, thickness of which gradually increases from the inner side toward the outer side of the cover body.

7. The luminaire according to claim 5, wherein, when a maximum emission angle with respect to the optical axis of the light emitted from the semiconductor light-emitting element is represented as r and a refractive index of the cover body is represented as n, an inclination angle θ of the inclined surface with respect to the light-emitting surface is set in a range satisfying r≧θ+arcsin(n*sin(−θ+arcsin(1/n)·180/π)).

8. The luminaire according to claim 1, wherein the cover body has a sectional shape, thickness of which gradually increases from the inner side toward the outer peripheral surface of the cover body.

9. The luminaire according to claim 2, wherein the outer surface separated from the attachment surface of the cover body close to the peripheral edge section of the front surface section inclines in a direction away from the attachment surface from the inner side toward the outer peripheral surface of the cover body.

10. The luminaire according to claim 1, wherein the cover body is manufactured by injection molding using a die.

11. The luminaire according to claim 1, wherein a fine uneven surface is formed on at least one of an outer side surface and an inner side surface of the cover body.

12. The luminaire according to claim 1, wherein a material of the cover body contains a material having a different refractive index that irregularly reflects light.
